(19) United States
(12) Patent Application Publication
(10) Pub. No.: US 2023/0245153 A1
(43) Pub. Date: Aug. 3, 2023

(54) SYSTEM AND METHOD FOR FACILITATING TRANSACTION OF AT LEAST ONE OF A PRODUCT AND A SERVICE

(71) Applicant: RAJENDRA SHAHAJIRAO PATIL, SANGLI (IN)

(72) Inventor: RAJENDRA SHAHAJIRAO PATIL, SANGLI (IN)

(21) Appl. No.: 18/192,693

(22) Filed: Mar. 30, 2023

(30) Foreign Application Priority Data
Dec. 15, 2020 (IN) 202021054526
Jan. 28, 2021 (WO) PCT/IB2021/050653

(51) Int. Cl. G06Q 30/0204; G06Q 30/02

(52) U.S. Cl. CPC G06Q 30/0205; G06Q 30/0281

(57) ABSTRACT

A system and a method for facilitating transaction of at least one of a product and a service is disclosed. A consumer requirement receiving subsystem identifies a real-time geographical location of the one or more consumers, displays a list of the one or more product or service providers, receives a plurality of product or service associated requests. A requirement matching subsystem, obtains product or service provider profile information corresponding to the plurality of product or service associated requests, processes purchase confirmation message. A price negotiation subsystem receives one or more price options corresponding to each of the at least one of a product and a service, enables the one or more product or service providers to finalize a pricing. A purchase request processing subsystem generates a unique token number corresponding to the at least one product and each of a service for providing real-time purchase request status.

### CROSS-REFERENCE TO RELATED APPLICATION

This Application claims priority from a Patent application filed in India having Patent Application No. 202021054526, filed on Dec. 15, 2020, and titled “SYSTEM AND METHOD FOR FACILITATING TRANSACTION OF AT LEAST ONE OF A PRODUCT AND A SERVICE” and a PCT Application No. PCT/IB2021/050653 filed on Jan. 28, 2021, and titled “SYSTEM AND METHOD FOR FACILITATING TRANSACTION OF AT LEAST ONE OF A PRODUCT AND A SERVICE.”

### BACKGROUND

Embodiments of the present disclosure relate to an electronic commerce system for managing online transactions and more particularly to a system and a method for facilitating transaction of at least one of a product and a service.

Electronic commerce system involves buying and selling of products or services over electronic systems such as the interne and other computer networks. The e-commerce system has revolutionized the concept of modern business and changed the idea of locating on a certain territory and focusing on a particular customer audience. Not only this, the electronic-commerce systems have also affected business of one or more brick and mortar stores where a customer need to visit the store and purchase one or more items from the stores. The electronic commerce system allows participation of multiple parties, such as merchants and customers, for transaction with each other and rate each other with a feedback or review system. Such electronic commerce systems are made public or private and are maintained internally by an individual or externally by a group of organizations. Various systems are available which allow customers to search for nearby merchants for customer-specified products or services in online marketplaces.

Conventionally, the electronic commerce systems which are available in markets encourages participation of one or more giant sellers or companies to allow selling of one or more products or services. However, such a conventional system with the involvement of the one or more giant sellers discourage participation of one or more small-scale service providers or local sellers in a hypermarket platform due to higher competition. Moreover, such a conventional system is unable to obtain information of a list of items available at one or more local stores, their prices and demand of the one or more customers associated with such list of the items and thus makes purchasing process from the giant sellers more time-consuming and complicated. Also, such a conventional system is unable to manage selling of both products as well as services from a single unified hypermarket platform which further deviates the customer to several other online marketplaces.

Hence, there is a need for an improved system and a method for facilitating transaction of at least one of a product and a service in order to address the aforementioned issues.

### BRIEF DESCRIPTION

In accordance with an embodiment of the present disclosure, a system for facilitating transaction of at least one of a product and a service is disclosed. The system includes a user registration subsystem configured to register one or more product or service providers, one or more merchants and one or more consumers by receiving a plurality of corresponding registration details for enabling participation in transaction activity of at least one of a product and a service. The system also includes a consumer requirement receiving subsystem operatively coupled to the user registration subsystem. The consumer requirement receiving subsystem is configured to identify a real-time geographical location of the one or more consumers using one or more location fetching techniques upon login operation performed by the one or more consumers. The consumer requirement receiving subsystem is also configured to display a list of the one or more product or service providers available in proximity to the real-time geographical location of the one or more consumers identified. The consumer requirement receiving subsystem is also configured to receive a plurality of product or service associated requests from the one or more consumers in one or more formats based on matching of the real-time geographical location of the one or more consumers with the one or more product or service providers. The system also includes a requirement matching subsystem operatively coupled to the consumer requirement receiving subsystem. The requirement matching subsystem is configured to obtain product or service provider profile information corresponding to the plurality of product or service associated requests received from the one or more consumers. The requirement matching subsystem is also configured to match the plurality of product or service associated requests with the product or service provider profile information obtained. The requirement matching subsystem is also configured to process a purchase confirmation message for purchasing the at least one of a product and a service upon selection by the one or more consumers based on a matching result of the plurality of product or service associated requests and the product or service provider profile information. The system also includes a price negotiation subsystem operatively coupled to the requirement matching subsystem. The price negotiation subsystem is configured to receive one or more price options corresponding to each of the at least one of a product and a service from the one or more consumers upon processing the purchase confirmation message. The price negotiation subsystem is also configured to enable the one or more product or service providers to finalize a pricing for each of the at least one of a product and a service amongst the one or more price options received within a predefined time interval based on a plurality of negotiating factors. The system also includes a purchase request processing subsystem operatively coupled to the price negotiation subsystem. The purchase request processing subsystem is configured to generate a unique token number corresponding to the at least one of a product and each of the at least one of a service purchased at a final price value by the one or more consumers. The purchase request processing subsystem is also configured to provide a real-time purchase request status associated with the at least one of a product and each of the at least one of a service for facilitating purchasing activity using the unique token number generated

In accordance with another embodiment of the present disclosure, a method for facilitating transaction of at least one of a product and a service is disclosed. The method includes registering, by a user registration subsystem, one or more product or service providers, one or more merchants and one or more consumers by receiving a plurality of corresponding registration details for enabling participation in transaction activity of at least one of a product and a service. The method also includes identifying, by a consumer receiving subsystem, a real-time geographical location of the one or more consumers using one or more location fetching techniques upon login operation performed by the one or more consumers. The method also includes displaying, by the consumer receiving subsystem, a list of the one or more product or service providers available in proximity to the real-time geographical location of the one or more consumers identified. The method also includes receiving, by the consumer receiving subsystem, a plurality of product or service associated requests from the one or more consumers in one or more formats based on matching of the real-time geographical location of the one or more consumers with the one or more product or service providers. The method also includes obtaining, by a requirement matching subsystem, product or service provider profile information corresponding to the plurality of product or service associated requests received from the one or more consumers. The method also includes matching, by the requirement matching subsystem, the plurality of product or service associated requests with the product or service provider profile information obtained. The method also includes processing, by the requirement matching subsystem, a purchase confirmation message for purchasing the at least one of a product and a service upon selection by the one or more consumers based on a matching result of the plurality of product or service requests and the product or service provider profile information. The method also includes receiving, by a price negotiation subsystem, one or more price options corresponding to each of the at least one of a product and a service upon processing the purchase confirmation message from the one or more consumers. The method also includes enabling, by the price negotiation subsystem, the one or more product or service providers to finalize a pricing for each of the at least one of a product and a service amongst the one or more price options received within a predefined time interval based on a plurality of negotiating factors. The method also includes generating, by a purchase request processing subsystem, a unique token number corresponding to the at least one of a product and each of the at least one of a service purchased at a final price value by the one or more consumers. The method also includes providing, by the purchase request processing subsystem, a real-time purchase request status associated with the at least one of a product and each of the at least one of a service for facilitating purchasing activity using the unique token number generated.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for facilitating transaction of at least one of a product and a service in accordance with an embodiment of the present disclosure;

FIG. 2 is a block diagram of an embodiment of a system for facilitating transaction of at least one of a product and a service in accordance with an embodiment of the present disclosure

FIG. 3 is a block diagram of an exemplary system for facilitating transaction of at least one of a product and a service in accordance with an embodiment of the present disclosure;

FIG. 4 illustrates a block diagram of a computer or a server of FIG. 1 in accordance with an embodiment of the present disclosure; and

FIG. 5 (a) and FIG. 5 (b) represents a flow chart illustrating the steps involved in a method for facilitating transaction of at least one of a product and a service in accordance with the embodiment of the present disclosure.

Further, those skilled in the art will appreciate that elements in the figures are illustrated for simplicity and may not have necessarily been drawn to scale, Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprise”, “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for facilitating transaction of at least one of a product and a service. The system includes a user registration subsystem configured to register one or more product or service providers, one or more merchants and one or more consumers by receiving a plurality of corresponding registration details for enabling participation in transaction activity of at least one of a product and a service. The system also includes a consumer requirement receiving subsystem operatively coupled to the user registration subsystem. The consumer requirement receiving subsystem is configured to identify a real-time geographical location of the one or more consumers using one or more location fetching techniques upon login operation performed by the one or more consumers. The consumer requirement receiving subsystem is also configured to display a list of the one or more product or service providers available in proximity to the real-time geographical location of the one or more consumers identified. The consumer requirement receiving subsystem is also configured to receive a plurality of product or service associated requests from the one or more consumers in one or more formats based on matching of the real-time geographical location of the one or more consumers with the one or more product or service providers. The system also includes a requirement matching subsystem operatively coupled to the consumer requirement receiving subsystem. The requirement matching subsystem is configured to obtain product or service provider profile information corresponding to the plurality of product or service associated requests received from the one or more consumers. The requirement matching subsystem is also configured to match the plurality of product or service associated requests with the product or service provider profile information obtained, The requirement matching subsystem is also configured to process a purchase confirmation message for purchasing the at least one of a product and a service upon selection by the one or more consumers based on a matching result of the plurality of product or service associated requests and the product or service provider profile information. The system also includes a price negotiation subsystem operatively coupled to the requirement matching subsystem. The price negotiation subsystem is configured to receive one or more price options corresponding to each of the at least one of a product and a service from the one or more consumers upon processing the purchase confirmation message. The price negotiation subsystem is also configured to enable the one or more product or service providers to finalize a pricing for each of the at least one of a product and a service amongst the one or more price options received within a predefined time interval based on a plurality of negotiating factors. The system also includes a purchase request processing subsystem operatively coupled to the price negotiation subsystem. The purchase request processing subsystem is configured to generate a unique token number corresponding to the at least one of a product and each of the at least one of a service purchased at a final price value by the one or more consumers, The purchase request processing subsystem is also configured to provide a real-time purchase request status associated with the at least one of a product and each of the at least one of a service for facilitating purchasing activity using the unique token number generated

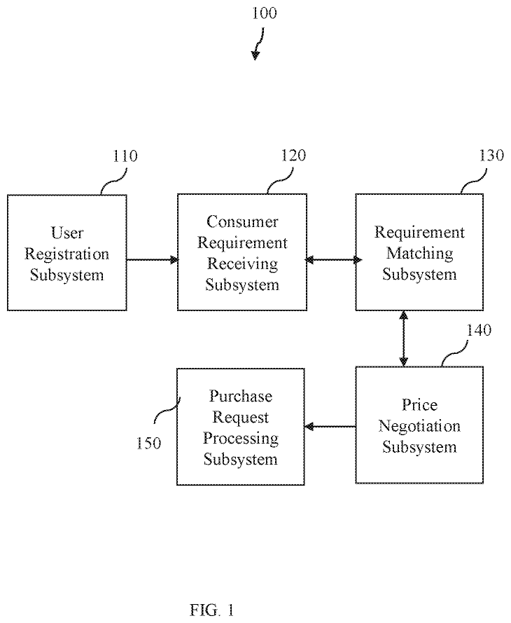

FIG. 1 is a block diagram of a system 100 for facilitating transaction of at least one of a product and a service in accordance with an embodiment of the present disclosure. The system 100 includes a user registration subsystem 110 configured to register one or more product or service providers, one or more merchants and one or more consumers by receiving a plurality of corresponding registration details for enabling participation in transaction activity of at least one of a product and a service. As used herein, the term ‘one or more product or service providers’ is defined as one or more local sellers engaged in selling of one or more products or services. Similarly, the term ‘one or more merchants’ is defined as one or more non-retail market wholesalers or distributors or industries or organizations or individuals and the like who are engaged in selling of one or more products in (non B2C) other than business to consumer marketplace. Again, the term ‘consumers’ is defined as one or more buyers or end-user customers interested in purchasing one or more products or services. In one embodiment, receiving the plurality of corresponding registration details may include, but not limited to, receiving at least one of a name, a registered identification number, a contact detail, an address proof details or a combination thereof.

The system 100 also includes a consumer requirement receiving subsystem 120 operatively coupled to the user registration subsystem 110. The consumer requirement receiving subsystem 120 is configured to identify a real-time geographical location of the one or more consumers using one or more location fetching techniques upon login operation performed by the one or more consumers. In one embodiment, the one or more location fetching techniques may include an automated location fetching from an electronic device associated with the one or more consumers. In such embodiment, the electronic device including, but not limited to a mobile phone, a laptop, a desktop, a tablet and the like may be utilized by the one or more consumers for the login operation. In another embodiment, the one or more location fetching technique may include fetching geographical location based on a consumer's location selection. In such embodiment, the one or more consumers may adjust and expand a predetermined locality radius of the geographical location based on his or her preference and requirement. The predetermined locality radius is adjusted by the one or more consumers within a nearby local area, colony, pin code, city, district, state, country in retail as well as non-retail market to promote local procurement, encourage, uplift protect local ecosystem of supply chain of the at least one of a product and a service.

The consumer requirement receiving subsystem 120 is also configured to display a list of the one or more product or service providers available in proximity to the real-time geographical location of the one or more consumers identified. The consumer requirement receiving subsystem 120 is also configured to receive a plurality of product or service associated requests from the one or more consumers in one or more formats based on matching of the real-time geographical location of the one or more consumers with the one or more product or service providers. In one embodiment, the plurality of product or service associated requests comprises one or more attributes corresponding to the one or more product or service providers, one or more attributes corresponding to the at least one of a product and a service, a response for the purchase confirmation message or a combination thereof. In such embodiment, the one or more attributes corresponding to the one or more product or service providers may include but not limited to, a category of the one or more product or service providers, a name of the one or more product or service providers, a brand of the one or more product or service providers and the like. In another embodiment, the one or more attributes corresponding to the at least one of a product and a service may include, but not limited to, a category of the at least one of a product and a service, a name of the at least one of a product and a service, a brand of the one or more product or services, a quantity of the at least one of a product and a service and the like. In some embodiment, the response of the purchase confirmation message which is received as an input may include a yes response or a no response. In one embodiment, the plurality of product or service associated requests may include a price negotiation input received from the one or more consumers. In a specific embodiment, the plurality of products or services associated requests may be received from the one or more consumers simultaneously. In another embodiment, the plurality of product or service associated requests may be received from the one or more consumers consecutively.

In one embodiment, the plurality of product or service associated requests may be received in at least one of a voice format, a text format, an image format or a combination thereof. In such embodiment, the voice format for the plurality of product or service requests provides ease of comfort simplicity for disabled people and aged people. The voice format helps in quick navigation for searching the one or more products into a shop to complete the product or service purchase request. The consumer requirement receiving subsystem also enables online translation of the at least one of a product and a service detail into one or more languages to support each member such as the one or more product or service providers, the one or more consumers and the one or more merchants of a community to participate equally in the ecosystem without language barrier, In one embodiment, the one or more languages may include, but not limited to, one or more regional languages, one or more national languages, one or more official languages and the like.

The system also includes a requirement matching subsystem 130 operatively coupled to the consumer requirement receiving subsystem 120. The requirement matching subsystem 130 is configured to obtain product or service provider profile information corresponding to the plurality of product or service associated requests received from the one or more consumers. The requirement matching subsystem 130 is also configured to match the plurality of product or service associated requests with the product or service provider profile information obtained. In one embodiment, the one or more product or service providers profile information may include at least one of available time of the one or more product or service providers, a category of the one or more product or service providers, a shop name of the one or more product or service providers, a brand of the at least one of a product and a service available with the one or more product or service providers, a brand name of the one or more product or service providers, name of the at least one of a product and a service available with the one or more product or service providers , an available product quantity, a type of the at least one of a product and a service available, a type of delivery option available with the one or more product or service providers, price offered by the one or more product or service providers or a combination thereof. In such embodiment, the type of delivery option available may include, but not limited to, a home delivery option, a takeaway delivery option, a conditional delivery option by a shop and the like. In some embodiment, the conditional delivery option may include, but not limited to, a delivery only above a predefined amount, delivery within a predefined radius, delivery during a predefined time period, delivery to a particular floor of a building without lift, service request within specific days and the like.

The requirement matching subsystem 130 is also configured to process a purchase confirmation message for purchasing the at least one of a product and a service upon selection by the one or more consumers based on a matching result of the plurality of product or service associated requests and the product or service provider profile information. In one embodiment, the purchase confirmation message may comprise selection of the at least one of a product and a service by visiting a website of the one or more local shops by the one or more consumers, wherein the website is accessed by an interface provided through, but not limited to, a web-based application, a mobile application and the like. In another embodiment, the purchase confirmation message may be received based on selection of the at least one of a product and a service by the one or more consumers via visiting the interface of a hypermarket platform provided through, but not limited to, web-based application, mobile application and the like.

The system also includes a price negotiation subsystem 140 operatively coupled to the requirement matching subsystem 130. The price negotiation subsystem 140 is configured to receive one or more price options corresponding to each of the at least one of a product and a service from the one or more consumers upon processing the purchase confirmation message. The price negotiation subsystem 140 is also configured to enable the one or more product or service providers to finalize a pricing for each of the at least one of a product and a service amongst the one or more price options received within a predefined time interval based on a plurality of negotiating factors. In one embodiment, the plurality of negotiating factors may include, but not limited to, at least one of a quantity of product purchased, a quality of product purchased, a time of delivery of the product purchased, a quality of service requested by the consumer, a consumer relationship with the one or more product or service providers, a brand of the product purchased, a profit associated with selling of the product or service and the like.

The system 100 also includes a purchase request processing subsystem 150 operatively coupled to the price negotiation subsystem 140. The purchase request processing subsystem 150 is configured to generate a unique token number corresponding to the at least one of the product and each of the at least one of a service purchased at a final price value by the one or more consumers. In one embodiment, the unique token number may include a serial number corresponding to booking or purchasing of the at least one of a product and a service. The unique token number enables the one or more consumers to visualize a current sequence number of the plurality of product or service associated requests attained in a queue. The unique token number enables coupling or incorporating remote entry of a plurality of product or service purchase requests into the queue for a particular shop or service facility and subsequently knowing the particular request or the real-time purchase request status as well as queue live status. Thus, the one or more consumers by viewing the real-time queue status may accordingly start from his or her home, workplace, safe place. The purchase request processing subsystem 150 is also configured to provide the real-time purchase request status associated with the at least one of a product and each of the at least one of a service for facilitating purchasing activity using the unique token number generated. For example, each of the at least one service booked at one particular shop at a particular time slot is linked with a unique token number corresponding to each of the at least one service whereas, the at least one product purchased from a particular shop at a particular time slot has a single unique token number corresponding to the at least one product purchased. In one embodiment, the real-time purchase request status may include at least one of a queue number, number of consumers waiting in a queue, a ready for delivery or takeaway notification for the at least of a product and a service, a delivery confirmation notification for the at least one of a product and a service, a shipping notification for the at least one of a product and a service, an out for delivery notification for the at least one of a product and a service, a service provisioning notification and the like.

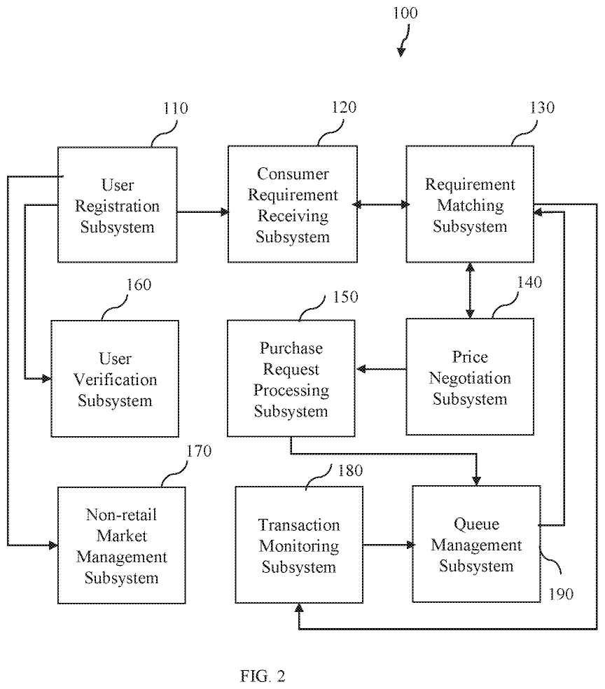

FIG. 2 is a block diagram of an embodiment of a system for facilitating transaction of at least one of a product and a service in accordance with an embodiment of the present disclosure. As described in aforementioned FIG. 1, the system 100 includes a user registration subsystem 110, a consumer requirement receiving subsystem 120, a requirement matching subsystem 130, a price negotiation subsystem 140 and a purchase request processing subsystem 150. In addition, the system 100 also includes a user verification subsystem 160 operatively coupled to the user registration subsystem. The user verification subsystem 160 is configured to verify authenticity of each of the one or more product or service providers and the one or more merchants for participating in the transaction activity based on validation of the plurality of the corresponding registration details. The authenticity of the each of the one or more product or service providers are verified based on verification and validation of each of a plurality of registration details during initial registration process. In one embodiment, each of the plurality of registration details may include, but not limited to, one or more registered documents such as government authorized registration certificate, government authorized identity card and the like uploaded by the one or more product or service providers and the one or more merchants. In such embodiment, the one or more registered documents may be scanned using an optical character recognition (OCR) technique. Scanned details fetched from the one or more registered documents are matched with profile information uploaded by the one or more product or service providers or the one or more merchants. The user verification subsystem 160 is also configured to provide verification tags in addition to ratings tags to each of the one or more product or service providers and the one or more merchants for participating in the transaction activity by the one or more consumers, Verification of the users help in building the trust among the local ecosystem which further leads to improvement of transaction activity for the one or more products or services.

Furthermore, the system 100 also includes a non-retail market management subsystem 170 operatively coupled to the user registration subsystem 110. The non-retail market management subsystem 170 is configured to facilitate the transaction activity for purchasing the at least one of a product and a service between the one or more product or service providers and the one or more merchants within a predetermined geographical location. For example, the non-retail market management subsystem 170 enables a grocery shop owner to see one or more product wholesalers in a predetermined geographical locality and enables to place his or her request/order. Similarly, the one or more product wholesalers may also be able to view one or more nearby distributors which in turn may see one or more nearby product manufacturers or factories which in turn can see may see one or more nearby raw material suppliers, one or more farmers and the like. The non-retail market management subsystem 170 also allows placing of the product or service purchase requests to the one or more satisfied merchants after reviewing multiple merchants, their product specifications, price, quantity, delivery time, delivery mode and the like. The non-retail market management subsystem also enables the one or more product or service providers to view a live order or a purchase request status associated with the one or more merchants. The non-retail market management subsystem 170 also enables remote entry of the one or more product or service providers into a queue without being physically present, viewing live queue status for the particular request/order and the like.

The system 100 also includes a transaction monitoring subsystem 180 operatively coupled to the requirement matching subsystem 130. The transaction monitoring subsystem 180 is configured to monitor performance of the one or more product or service providers or the one or more merchants based on a plurality of performance analysis factors, wherein the plurality of performance analysis factors comprises at least one of hours sales graph, daily sales graph, average time required per order request, brand wise sales, product wise sales, area wise sales or a combination thereof. The transaction monitoring subsystem 180 also monitors transaction activity associated with the one or more product or service providers who have more than one or more listed shops or service facility stations independently.

In addition, the system 100 also includes a queue management subsystem 190 operatively coupled to the purchase request processing subsystem 150. The queue management subsystem 190 is configured to dynamically manage the queue by considering online transaction process and an offline transaction process respectively based on the unique token number generated. The queue management subsystem 190 handles remote entry into the queue of a particular shop or the service facility station without being physically present at the shop or the service facility station for purchase of the one or more products or services. The queue management subsystem 190 enables the one or more consumers to view the real-time status of the queue in each of the product or service purchasing shops before placing a booking or purchase confirmation request to a particular product or a service provider whom the one or more consumers found satisfactory. Remote queue management helps in dynamically changing and sharing the live status of queue to all members in the queue in real time. Thus, the dynamic and remote queue management helps in implementation of social distancing and eliminating a need for the one or more consumers to wait in queue in front of shop hence reducing exposure to health hazards of the one or more consumers as well as the one or more product or service providers.

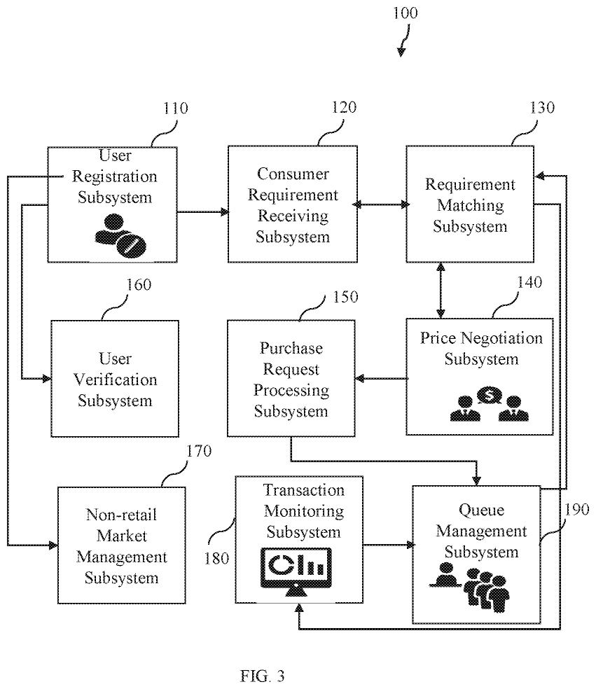

FIG. 3 is a block diagram of an exemplary system 100 for facilitating transaction of a product or a service in accordance with an embodiment of the present disclosure. Considering an example, where a consumer resides in a small town and wants to buy some flowers at a flower shop for pooja or worship, meet a tailor for tailoring needs, wants to purchase some medicines at a pharmacy and requires weekly vegetables and groceries from a vegetable shop and groceries shop respectively. In order to purchase all such stuffs from different places, the consumer needs to visit each of the shops physically and needs to wait in each of the queues for purchasing one or more products or services. The system 100 with utilization of advance technology helps in facilitating the transaction activity for purchasing the one or more products or services through an online interface. The system 100 enables participation of each of the local sellers or one or more product or service providers in a unified online marketplace and helps the consumer in shopping from the local marketplace through a web-based application, mobile application and the like.

A user registration subsystem 110 is configured to register one or more product or service providers, one or more merchants and the consumers by receiving a plurality of corresponding registration details for enabling participation in transaction activity of a product or a service. Upon receiving the corresponding registration details, a user verification subsystem 160 verifies authenticity of each of the one or more product or service providers and the one or more merchants for participating in the transaction activity based on validation of the plurality of the corresponding registration details. The authenticity of the each of the one or more product or service providers are verified based on verification and validation of each of a plurality of registration details during initial registration process.

A consumer requirement receiving subsystem 120 identifies a real-time geographical location of the one or more consumers using one or more location fetching techniques upon login operation performed by the consumer. For example, the one or more location fetching techniques may include an automated location fetching from an electronic device associated with the consumer. In the example used herein, the electronic device may include, but not limited to a mobile phone, a laptop, a desktop, a tablet and the like which is utilized by the consumer for the login operation. Once, the location is identified, the customer requirement receiving subsystem 120 also displays a list of the one or more product or service providers available in proximity to the real-time geographical location of the consumer. The geographical location in proximity to the one or more consumers include a predetermined locality radius within a nearby local area, colony, pin code, city, district in retail as well as non-retail market to promote local procurement, encourage, uplift protect local ecosystem of supply chain of the one or more products as well as one or more services. Also, the consumer request receiving subsystem 120 receives a plurality of product or service associated requests from the consumer in one or more formats. In the example used herein, the plurality of product or service associated requests comprises one or more attributes corresponding to the one or more product or service providers, one or more attributes corresponding to the at least one of a product and a service, a response for the purchase confirmation message or a combination thereof. Once, the plurality of products or service associated requests are received, a requirement matching subsystem 130 obtains product or service provider profile information corresponding to the plurality of product or service associated requests received from the one or more consumers. The requirement matching subsystem 130 is also configured to match the plurality of product or service associated requests with the product or service provider profile information obtained. For example, the one or more product or service providers profile information may include at least one of at least one of available time of the one or more product or service providers, a category of the one or more product or service providers, a shop name of the one or more product or service providers, a brand of the at least one of a product and a service available with the one or more product or service providers, a name of the at least one of a product and a service available with the one or more product or service providers, a brand name of the one or more product or service providers, an available product quantity, a type of the at least one of a product and a service available, a type of delivery option available with the one or more product or service providers, price offered by the one or more product or service providers & the like or a combination thereof. Based on matching of the plurality of product or service requests and the product or service provider profile information, the requirement matching subsystem 130 receive a purchase confirmation message for purchasing the at least one of a product and a service upon selection by the consumer. Later, in order to a provide a real-life shopping experience, a price negotiation subsystem 140 receives one or more price options corresponding to each of the at least one of the product and the service upon receiving the purchase confirmation message. The one or more price options helps the consumer in fixing the price of the at least one of the product and the service which are found costlier and highly priced without worth. The price negotiation subsystem 140 also enables the one or more product or service providers to finalize a pricing for each of the at least one of a product and a service amongst the one or more price options received within a predefined time interval based on a plurality of negotiating factors. For example, the plurality of negotiating factors may include at least one of a quantity of product purchased, a quality of product purchased, a time of delivery of the product purchased, a quality of service requested by the consumer, a consumer relationship with the one or more product or service providers, a brand of the product purchased, a profit associated with selling of the product or service or a combination thereof.

Again, upon finalization of the product or service price value, a purchase request processing subsystem 150 generate a unique token number corresponding to the at least one of the product and each of the at least one of a service purchased at a final price value by the consumer. The unique token number enables the consumer to visualize a current sequence number of the at least one of a product and a service purchasing requests attained in a queue. The unique token number enables coupling or incorporating remote entry of the plurality of product or service purchase requests into the queue for a particular shop or service facility and subsequently knowing the particular request or the real-time purchase request status as well as queue live status such as in the flower shop, the vegetable shop, the fruit shop, the medical shop and the like. Thus, the consumer by viewing the real-time queue status may accordingly start from his or her home, workplace, safe place. The purchase request processing subsystem is also configured to provide the real-time purchase request status associated with the at least one of a product and each of the at least one of a service for facilitating purchasing activity using the unique token number generated. In the example used herein, the real-time purchase request status may include at least one of a queue number, number of consumers waiting in a queue, a ready for delivery or takeaway notification for the at least of a product and a service, a delivery confirmation notification for the at least one of a product and a service, a shipping notification for the at least one of a product and a service, an out for delivery notification for the at least one of a product and a service, a service provisioning notification or a combination thereof

Furthermore, the system 100 also includes a non-retail market management subsystem 170 to facilitate the transaction activity for purchasing the at least one of a product and a service between the one or more product or service providers and the one or more merchants within a predetermined geographical location. In the above-mentioned example, the non-retail market management subsystem 170 enables a grocery shop owner from which the consumer is purchasing groceries, to see one or more product wholesalers in a predetermined geographical locality and enables to place his or her request order. Similarly, the one or more product wholesalers may also be able to view one or more nearby distributors which in turn may see one or more nearby product manufacturers or factories which in turn can see may see one or more nearby raw material suppliers, one or more farmers and the like.

In addition, a transaction monitoring subsystem 180 monitors performance of the one or more product or service providers or the one or more merchants based on a plurality of performance analysis factors, wherein the plurality of performance analysis factors may include at least one of hours sales graph, daily sales graph, average time required per order request, brand wise sales, product wise sales, area wise sales or a combination thereof The transaction monitoring subsystem 180 also monitors transaction activity associated with the one or more product or service providers who have more than one or more listed shops or service facility stations independently.

Moreover, in order to dynamically manage the queue while purchasing the one or more products or services, a queue management subsystem 190 manages the queue by considering online transaction process and an offline transaction process respectively based on the unique token number generated. The queue management subsystem 190 handles remote entry into the queue of a particular shop or the service facility station without being physically present at the shop or the service facility station for purchase of the one or more products or services. Remote queue management helps in dynamically changing and sharing the live status of queue to all members in the queue in real time. Thus, the dynamic and remote queue management helps in implementation of social distancing and eliminating a need for the one or more consumers to wait in queue in front of shop hence reducing exposure to health hazards of the one or more consumers as well as the one or more product or service providers.

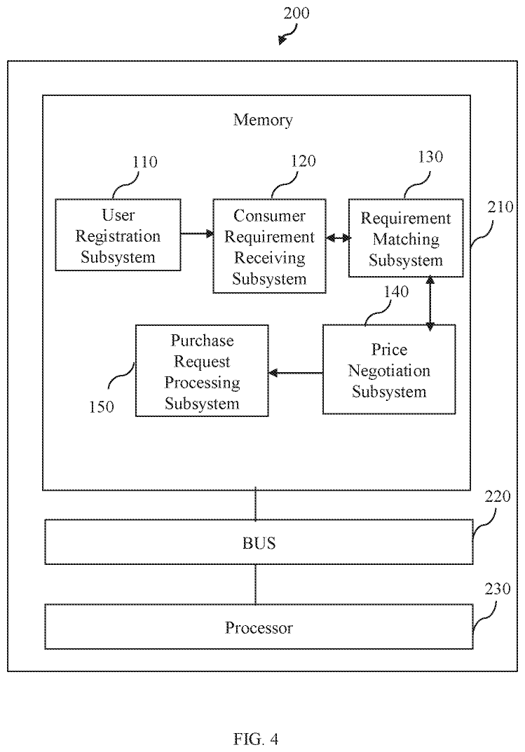

FIG. 4 illustrates a block diagram of a computer or a server of FIG. 1 in accordance with an embodiment of the present disclosure. The server 200 includes processors 230, and memory 210 operatively coupled to the bus 220. The processors 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 is substantially similar to a system 100 for facilitating a reverse auction process of FIG. 1. The memory 210 includes one or more subsystems of the system 100 such as: a user registration subsystem 110, a consumer requirement receiving subsystem 120, a requirement matching subsystem 130, a price negotiation subsystem 140 and a purchase request processing subsystem 150,

The user registration subsystem 110 configured to register one or more product or service providers, one or more merchants and one or more consumers by receiving a plurality of corresponding registration details for enabling participation in transaction activity of at least one of a product and a service. The consumer requirement receiving subsystem 120 is configured to identify a real-time geographical location of the one or more consumers using one or more location fetching techniques upon login operation performed by the one or more consumers. The consumer requirement receiving subsystem 120 is also configured to display a list of the one or more product or service providers available in proximity to the real-time geographical location of the one or more consumers identified. The consumer requirement receiving subsystem is also configured to receive a plurality of product or service associated requests from the one or more consumers in one or more formats based on matching of the real-time geographical location of the one or more consumers with the one or more product or service providers, The requirement matching subsystem 130 is configured to obtain product or service provider profile information corresponding to the plurality of product or service associated requests received from the one or more consumers. The requirement matching subsystem 130 is also configured to match the plurality of product or service associated requests with the product or service provider profile information obtained. The requirement matching subsystem 130 is also configured to process a purchase confirmation message for purchasing the at least one of a product and a service upon selection by the one or more consumers based on a matching result of the plurality of product or service associated requests and the product or service provider profile information. The price negotiation subsystem 140 is configured to receive one or more price options corresponding to each of the at least one of a product and a service from the one or more consumers upon receiving the purchase confirmation message. The price negotiation subsystem 140 is also configured to enable the one or more product or service providers to finalize a pricing for each of the at least one of a product and a service amongst the one or more price options received within a predefined time interval based on a plurality of negotiating factors. The purchase request processing subsystem 150 is configured to generate a unique token number corresponding to the at least one of a product and each of the at least one of a service purchased at a final price value by the one or more consumers. The purchase request processing subsystem 150 is also configured to provide a real-time purchase request status associated with the at least one of a product and each of the at least one of a service for facilitating purchasing activity using the unique token number generated.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

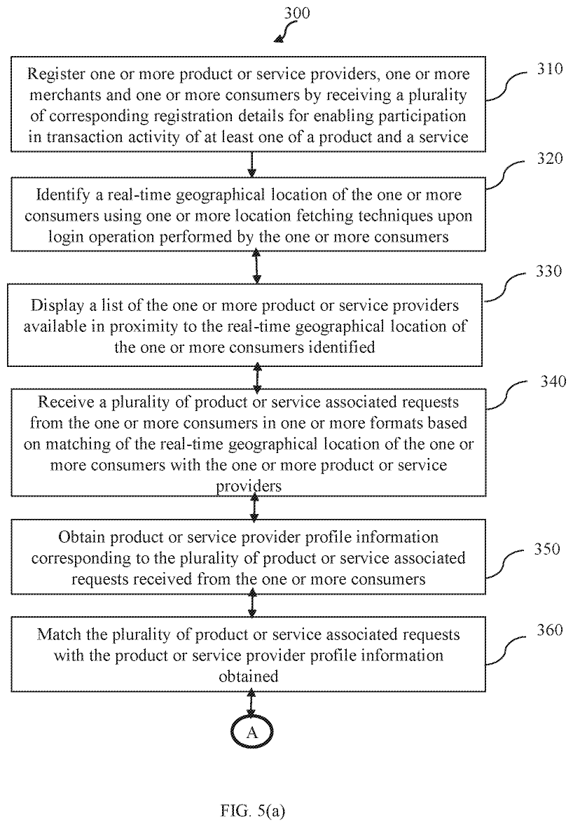

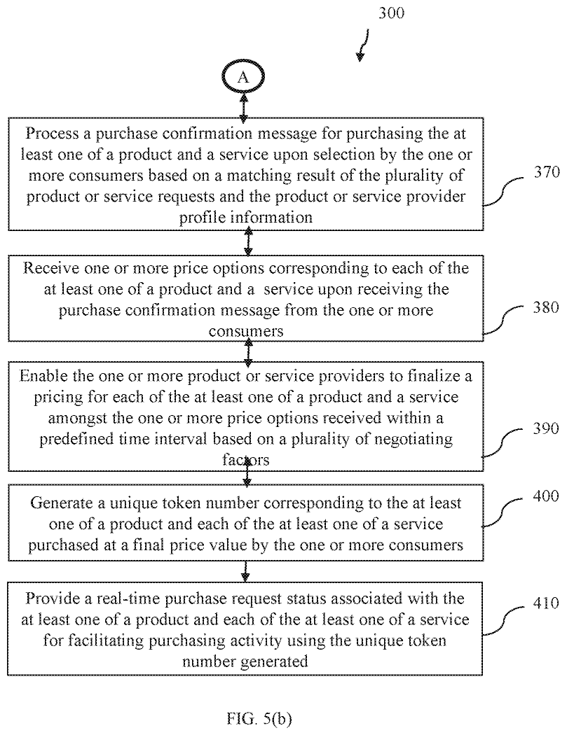

FIG. 5 (a) and FIG. 5 (b) represents a flow chart illustrating the steps involved in a method for facilitating transaction of at least one of a product and a service in accordance with the embodiment of the present disclosure. The method 300 includes registering, by a user registration subsystem, one or more product or service providers, one or more merchants and one or more consumers by receiving a plurality of corresponding registration details for enabling participation in transaction activity of at least one of a product and a service in step 310. In one embodiment, registering the one or more product or service providers, the one or more merchants and the one or more consumers by receiving the plurality of corresponding registration details for enabling participation in the transaction activity may include registering the one or more product or service providers, the one or more merchants and the one or more consumers by receiving at least one of a name, a registered identification number, a contact detail, an address proof details or a combination thereof.

The method 300 also includes identifying, by a consumer receiving subsystem, a real-time geographical location of the one or more consumers using one or more location fetching techniques upon login operation performed by the one or more consumers in step 320. The method 300 also includes displaying, by the consumer receiving subsystem, a list of the one or more product or service providers available in proximity to the real-time geographical location of the one or more consumers identified in step 330. In some embodiment, displaying the one or more product or service providers available in proximity to the geographical location of the one or more consumers may include identifying location of the one or more product or service providers in proximity to the geographical location using a geo-fencing technique.

The method 300 also includes receiving, by the consumer receiving subsystem, a plurality of product or service associated requests from the one or more consumers in one or more formats based on matching of the real-time geographical location of the one or more consumers with the one or more product or service providers in step 340. In one embodiment, receiving the plurality of the product or the service associated requests from the one or more consumers may include receiving at least one of one or more attributes corresponding to the one or more product or service providers, one or more attributes corresponding to the at least one of a product and a service, a response for the purchase confirmation message or a combination thereof. In such embodiment, the plurality of product or service associated requests may be received in at least one of a voice format, a text format, an image format or a combination thereof.

The method 300 also includes obtaining, by a requirement matching subsystem, product or service provider profile information corresponding to the plurality of product or service associated requests received from the one or more consumers in step 350. The method 300 also includes matching, by the requirement matching subsystem, the plurality of product or service associated requests with the product or service provider profile information obtained in step 360.

The method 300 also includes processing, by the requirement matching subsystem, a purchase conformation message for purchasing the at least one of a product and a service upon selection by the one or more consumers based on a matching result of the plurality of product or service requests and the product or service provider profile information in step 370. In one embodiment, processing the purchase confirmation message for purchasing the at least one of the product and the service from the one or more consumers based on matching of the plurality of product or service associated requests and the product or service provider profile information may include matching of the plurality of product or service associated requests with at least one of available time of the one or more product or service providers, an available product quantity, a type of product available, a list of services available, a type of delivery option available with the seller, price offered by the seller and the like or a combination thereof. In such embodiment, the type of delivery option available may include, but not limited to, a home delivery option, a takeaway delivery option, a conditional delivery option by a shop and the like. In some embodiment, the conditional delivery option may include, but not limited to, a delivery only above a predefined amount, delivery within a predefined radius, delivery during a predefined time period, delivery to a particular floor of a building without lift, service request within specific days and the like.

The method 300 also includes receiving, by a price negotiation subsystem, one or more price options corresponding to each of the at least one of a product and a service upon processing the purchase conformation message from the one or more consumers in step 380, In some embodiment, receiving the one or more price options corresponding to each of the at least one of a product and a service upon receiving the purchase confirmation message may include receiving the purchase confirmation message upon selection of the one or more products or services by visiting a website of the one or more local shops by the one or more consumers, wherein the website is accessed by an interface provided through, but not limited to, a web based application, a mobile application and the like. In another embodiment, the purchase confirmation message may be received based on selection of the at least one of a product and a service by the one or more consumers via visiting the interface of a hypermarket platform provided through, but not limited to, web-based application, mobile application and the like,

The method 300 also includes enabling, by the price negotiation subsystem, the one or more product or service providers to finalize a pricing for each of the at least one of a product and a service amongst the one or more price options received within a predefined time interval based on a plurality of negotiating factors in step 390. In one embodiment, enabling the one or more product or service providers to finalize the pricing for each of the at least one of the product and a service amongst the one or more price options may include finalizing the pricing based on at least one of a quantity of product purchased, a quality of product purchased, a time of delivery of the product purchased, a quality of service requested by the consumer, a consumer relationship with the one or more product or service providers, a brand of the product purchased, a profit associated with selling of the product or service or a combination thereof.

The method 300 also includes generating, by a purchase request processing subsystem, a unique token number corresponding to the at least one of a product and each of the at least one of a service purchased at a final price value by the one or more consumers in step 400. The method 300 also includes providing, by the purchase request processing subsystem, a real-time purchase request status associated with the at least one of a product and each of the at least one of a service for facilitating purchasing activity using the unique token number generated in step 410. In one embodiment, providing the real-time purchase status associated with each of the one or more products or services may include providing the real-time purchase status including at least one of a queue number, number of consumers waiting in a queue, a delivery confirmation notification for at least one of a product and a service, a shipping notification for at least one of a product and a service, an out for delivery notification for at least one of a product and a service, a service provisioning notification or a combination thereof.

Various embodiments of the present disclosure provide an online hyper local listing platform for all product or service providers to sell or list their products as well as services which not only make the process of shopping easy but also saves time and effort of the one or more sellers as well as the one or more consumers.

Moreover, the present disclosed system by implementing of remote queue management eliminates the need of the one or more consumers to wait in queue in front of shop and thus also reduces exposure to health hazards. This further boost efficiency by approximately more than 100% of the one or more product or service providers as the sales activity gets approximately more than doubled without any need to manage or convince the one or more consumers for purchasing the one or more products or services.

Furthermore, the present disclosed system provides both offline and online shopping experience to the one or more consumers by providing opportunity to feel the product and ensure the desired quality by negotiating the price, change a particular product with another one of desired quality in case of requirement before making the payment in both retail as well as non-retail market.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A system for facilitating transaction of at least one of a product and a service comprising:
a user registration subsystem configured to register one or more product or service providers, one or more merchants and one or more consumers by receiving a plurality of corresponding registration details for enabling participation in transaction activity of at least one of a product and a service;
a consumer requirement receiving subsystem operatively coupled to the user registration subsystem, wherein the consumer requirement receiving subsystem is configured to:
identify a real-time geographical location of the one or more consumers using one or more location fetching techniques upon login operation performed by the one or more consumers;
display a list of the one or more product or service providers available in proximity to the real-time geographical location of the one or more consumers identified; and
receive a plurality of product or service associated requests from the one or more consumers in one or more formats based on matching of the real-time geographical location of the one or more consumers with the one or more product or service providers;
a requirement matching subsystem operatively coupled to the consumer requirement receiving subsystem, wherein the requirement matching subsystem is configured to:
obtain product or service provider profile information corresponding to the plurality of product or service associated requests received from the one or more consumers;
match the plurality of product or service associated requests he product or service provider profile information obtained; and
process a purchase confirmation message for purchasing the at least one of a product and a service upon selection by the one or more consumers based on a matching result of the plurality of product or service associated requests and the product or service provider profile information;
a price negotiation subsystem operatively coupled to the requirement matching subsystem, wherein the price negotiation subsystem is configured to:
receive one or more price options corresponding to each of the at least one of a product and a service from the one or more consumers upon processing the purchase confirmation message; and
enable the one or more product or service providers to finalize a pricing for each of the at least one of a product and a service amongst the one or more price options received within a predefined time interval based on a plurality of negotiating factors; and
a purchase request processing subsystem operatively coupled to the price negotiation subsystem, wherein the purchase request processing subsystem is configured to:
generate a unique token number corresponding to the at least one of a product and each of the at least one of a service purchased at a final price value by the one or more consumers; and
provide a real-time purchase request status associated with the at least one of a product and each of the at least one of a service for facilitating purchasing activity using the unique token number generated.

2. The system as claimed in claim 1, wherein the plurality of corresponding registration details comprises at least one of a name, a registered identification number, a contact detail, an address proof details or a combination thereof.

3. The system as claimed in claim 1, wherein the plurality of product or service requests comprise at least one of one or more attributes corresponding to the one or more product or service providers, one or more attributes corresponding to the at least one of a product and a service, a response for the purchase confirmation message or a combination thereof.

4. The system as claimed in claim 1, wherein the product or service providers profile information comprises at least one of available time of the one or more product or service providers, a category of the one or more product or service providers, a shop name of the one or more product or service providers, a brand of the at least one of a product and a service available with the one or more product or service providers, a name of the at least one of a product and a service available with the one or more product or service providers, a brand name of the one or more product or service providers, an available product quantity, a type of the at least one of a product and a service available, a type of delivery option available with the one or more product or service providers, price offered by the one or more product or service providers or a combination thereof.

5. The system as claimed in claim 1, wherein the purchase request status comprises at least one of a queue number, number of consumers waiting in a queue, a ready for delivery or takeaway notification for the at least of a product and a service, a delivery confirmation notification for the at least one of a product and a service, a shipping notification for the at least one of a product and a service, an out for delivery notification for the at least one of a product and a service, a service provisioning notification or a combination thereof.

6. The system as claimed in claim 1, comprising a user verification subsystem operatively coupled to the user registration subsystem, wherein the user verification subsystem is configured to verify authenticity of each of the one or more product or service providers and the one or more merchants for participating in the transaction activity based on validation of the plurality of the corresponding registration details.

7. The system as claimed in claim 1, comprising a non-retail market management subsystem operatively coupled to the user registration subsystem, wherein the non-retail market management subsystem is configured to facilitate the transaction activity for purchasing the at least one of a product and a service between the one or more product or service providers and the one or more merchants within a predetermined geographical location.

8. The system as claimed in claim 1, comprising a transaction monitoring subsystem operatively coupled to the requirement matching subsystem, wherein the transaction monitoring subsystem is configured to monitor performance of the one or more product or service providers or the one or more merchants based on a plurality of performance analysis factors, wherein the plurality of performance analysis factors comprises at least one of hours sales graph, daily sales graph, average time required per order request, brand wise sales, product wise sales, area wise sales or a combination thereof.

9. The system as claimed in claim 1, comprising a queue management subsystem operatively coupled to the purchase request processing subsystem, wherein the queue management subsystem is configured to dynamically manage the queue by considering online transaction process and an offline transaction process respectively based on the unique token number generated.

10. A method comprising:
registering, by a user registration subsystem, one or more product or service providers, one or more merchants and one or more consumers by receiving a plurality of corresponding registration details for enabling participation in transaction activity of at least one of a product and a service;
identifying, by a consumer receiving subsystem, a real-time geographical location of the one or more consumers using one or more location fetching techniques upon login operation performed by the one or more consumers;
displaying, by the consumer receiving subsystem, a list of the one or more product or service providers available in proximity to the real-time geographical location of the one or more consumers identified;
receiving, by the consumer receiving subsystem, a plurality of product or service associated requests from the one or more consumers in one or more formats based on matching of the real-time geographical location of the one or more consumers with the one or more product or service providers;
obtaining, by a requirement matching subsystem, product or service provider profile information corresponding to the plurality of product or service associated requests received from the one or more consumers;
matching, by the requirement matching subsystem, the plurality of product or service associated requests with the product or service provider profile information obtained;
processing, by the requirement matching subsystem, a purchase continuation message for purchasing the at least one of a product and a service upon selection by the one or more consumers based on a matching result of the plurality of product or service requests and the product or service provider profile information;
receiving, by a price negotiation subsystem, one or more price options corresponding to each of the at least one of a product and a service upon processing the purchase confirmation message from the one or more consumers;
enabling, by the price negotiation subsystem, the one or more product or service providers to finalize a pricing for each of the at least one of a product and a service amongst the one or more price options received within a predefined time interval based on a plurality of negotiating factors;
generating, by a purchase request processing subsystem, a unique token number corresponding to the at least one of a product and each of the at least one of a service purchased at a final price value by the one or more consumers; and
providing, by the purchase request processing subsystem, a real-time purchase request status associated with the at least one of a product and each of the at least one of a service for facilitating purchasing activity using the unique token number generated.
